(19) United States
(12) Patent Application Publication
(10) Pub. No.: US 2006/0278584 A1
(43) Pub. Date: Dec. 14, 2006

(54) Oil cleaning system and method

(76) Inventors: Robert William Bowden, Katy, TX (US); Gene Bruce Moss, Katy, TX (US); Vatsal Mukundlal Shah, Sugar Land, TX (US); Jerry Edward Teltschick, Houston, TX (US)

Correspondence Address: SHELL OIL COMPANY, P O BOX 2463, HOUSTON, TX, 772522463, US

(21) Appl. No.: 11/438,416

(22) Filed: May 22, 2006

Related U.S. Application Data
(60) Provisional application No. 60/684,006, filed on May 23, 2005.

(51) Int. Cl. B01D 17/06

(52) U.S. Cl. 210/739; 210/748; 210/96.1; 210/254

(57) ABSTRACT

An oil cleaning system is provided having an oil source and a re-circulating oil flow conduit that is in fluid communication with the oil source and operable to draw an oil flow stream therefrom. A barrier filter is further provided and positioned in the oil flow conduit to filter particles from the flow stream. An electrostatic fluid cleaner is also positioned in the oil flow conduit downstream of the barrier filter to remove particles from oil flow exiting the barrier filter. Furthermore, a selectively operable bypass conduit is provided that is fluidly connected to the oil flow conduit upstream of the electrostatic fluid cleaner. A sensor is positioned to detect a predetermined aqueous content upstream of the electrostatic fluid cleaner and to divert flow in the flowstream into the bypass conduit. The oil cleaning system also includes a sensor that is operatively associated with the bypass conduit and is positioned to detect a predetermined aqueous content in the flow stream upstream of the electrostatic cleaner. Upon detection of the predetermined aqueous content, flow in the flow stream is diverted through the bypass conduit.

The present application claims the benefit of pending U.S. Provisional Patent Application Ser. No. 60/684,006 filed May 23, 2005, the entire disclosure of which is hereby incorporated by reference.

### BACKGROUND OF THE INVENTION

The present invention relates generally to a fluid cleaning system and more particularly, to a system and method for cleaning oil flow. The system and method are particularly suited for removing contaminants from an industrial oil flow stream, and may employ one or more types of fluid cleaning devices and cleaning methods, including electrostatic fluid cleaning.

Industrial oils are commonly used in lubrication and hydraulic systems. Common industrial oils include hydraulic oils, turbine oils, compressor oils, gear oils, and circulating oils. It is generally known that a high percentage of failures experienced by machinery that incorporate one of these industrial oil systems is caused by a reduced performance or failure in the part of the industrial oil. In particular, the accelerated degradation of the oil and/or introduction of contaminants in the oil typically lead to such reduced performance and failures. Typical contaminants include water, metal wear particles, dust, fibers, and other debris. As the oil ages and oxidation occurs, oxidation byproducts provide another source of contamination. These byproducts include tars, varnishes, sludge and like materials.

Filtration systems are often incorporated with these industrial oil systems and employed to filter contaminants from the oil. Prior art filtration methods typically employ mechanical or barrier filters. Mechanical filtration may be employed to filter fine particles as low as one to three microns in size. For smaller, submicronic contaminants, mechanical filtration has proven to be significantly less effective in large commercial systems.

An alternative to mechanical filtration (i.e., the use of mechanical or barrier filters) is electrostatic oil cleaning (i.e., the use of electrostatic fluid filters). In an electrostatic oil cleaner, the oil is allowed to flow between electrodes with a high DC voltage across them. As the oil flows in between the charged electrodes, the submicronic particles are drawn towards the electrodes and, thereby, removed from the oil. A discussion of electrostatic fluid cleaners may be found in U.S. Pat. No. 6,129,829, which is hereby incorporated by reference for all purposes and made a part of the present disclosure.

### SUMMARY OF THE INVENTION

In one aspect of the present invention, an oil cleaning system is provided. The system includes an oil source and an oil flow conduit that is in fluid communication with the oil source and operable to draw a flow stream therefrom. Preferably, this oil flow conduit is a re-circulating line that draws from the oil source and returns cleaned oil flow into the oil source. The inventive system also includes a barrier filter positioned in the oil flow conduit to filter contaminants from the flow stream. An electrostatic fluid cleaner is positioned in the oil flow conduit downstream of the barrier filter so as to remove contaminants from oil flow exiting the barrier filter. Furthermore, a selectively operable bypass conduit is provided and is fluidly connected to the oil flow conduit upstream of the electrostatic fluid cleaner. The oil cleaning system further includes a sensor that is operatively associated with the bypass conduit and is positioned to detect a predetermined aqueous content in the flow stream upstream of the electrostatic fluid cleaner and to divert the flow stream into the bypass conduit.

In another aspect of the present invention, a method is provided for removing contaminants from industrial oil. The method includes drawing an oil flow stream from a source of industrial oil (e.g., an oil reservoir) and passing the flow stream through an oil flow conduit. Further, the flow stream is passed through a barrier filter so as to filter contaminant particles therefrom. The filtered flow stream exiting the barrier filter is then passed through an electrostatic fluid cleaner to further remove contaminants from the flow stream. Moreover, the method provides for detection of an aqueous content in the flow stream upstream of the electrostatic fluid cleaner. Upon detection of a predetermined aqueous content in the flow stream, the flow stream is diverted upstream of the electrostatic fluid cleaner into a bypass conduit.

### BRIEF DESCRIPTION OF THE DRAWINGS

The present invention may be best understood by way of example and in conjunction with the accompanying drawings, in which:

FIG. 1 is a simplified schematic of an oil cleaning system, according to the present invention; and

FIG. 2 is a simplified flow chart of an oil cleaning method, according to the present invention.

### DETAILED DESCRIPTION OF THE DRAWINGS

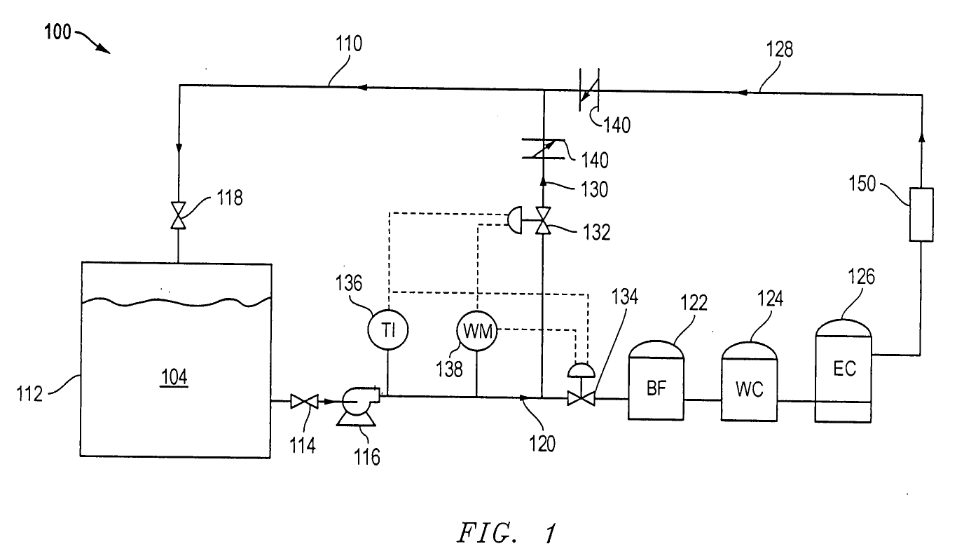

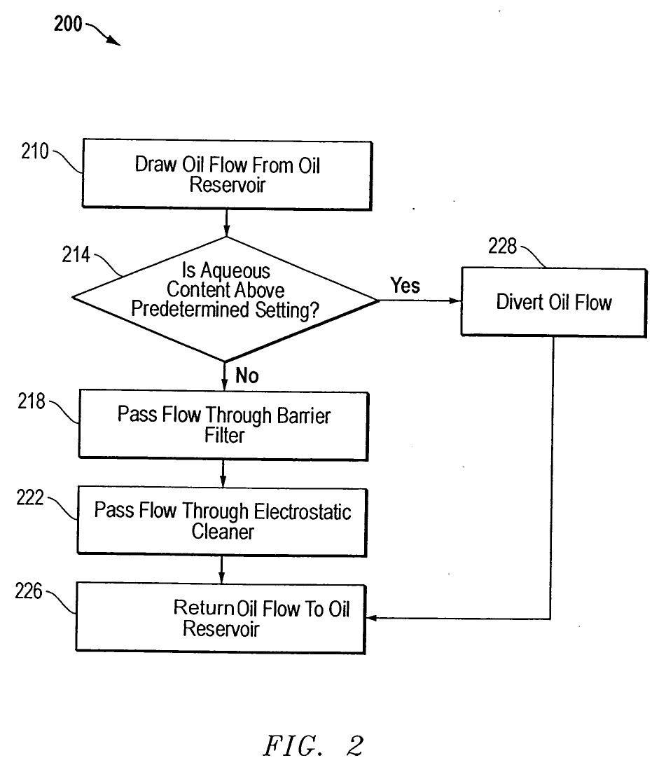

The present invention relates generally to a fluid cleaning system, and more particularly, a system and method for cleaning oil flow. The inventive system and method may be incorporated with or adjacent to an industrial oil system (e.g., hydraulic oil, turbine oil, etc.) so as to pass oil through one or more fluid cleaning devices and to remove target contaminants from the oil flow. FIGS. 1-2 embody various aspects of the invention.

The present invention takes advantage of the capability of electrostatic oil cleaners to remove insoluble submicronic contaminants from oil flow. In one aspect of the invention, the system effectively combines electrostatic oil cleaning with mechanical filtration (i.e., the use of mechanical or barrier filters). Among other things, the use of mechanical filters can generate a pressure differential that is undesirable in many applications. The oil flow through a barrier filter can also generate friction and thus, can generate static electricity in the oil flow. The accumulation of static electricity can cause a spark discharge at the outlet of the barrier filter or in the body of the fluid as the fluid finds an appropriate grounding location. Furthermore, at a temperature of several thousand degrees, the spark discharge quickly degrades the oil that it contacts. The present inventive system and method addresses these concerns, in one respect, by maintaining a relatively oil flow rate. The present inventive system and method also controls the aqueous content in the oil flow.

As used herein, the term “contaminants” shall refer to target particles, material, byproducts, and the like which are undesirable and thus removed from the industrial oil flow (according to the present method). Furthermore, the terms “removing contaminants” shall refer to a process of removing these “contaminants” from oil flow by way of filtering, electrostatic oil cleaning, or other processes.

It should first be noted, however, that the system and method illustrated in these Figures and the accompanying description are provided for exemplary purposes only. It will become apparent to one skilled in the mechanical, chemical, or other relevant art, upon a reading of the present description and/or viewing of the accompanying drawings, that variations and modifications to the system and a method associated therewith may be made, without departing from the scope and spirit of the invention. Thus, the description of exemplary applications as provided herein should not be construed to limit the invention to the specific methods and structures described.

FIG. 1 is a simplified schematic of an oil cleaning system 100, according to the present invention. The oil cleaning system 100 provides a re-circulating conduit 110 that draws industrial oil 104 from an oil reservoir 112, or other fluid source. The oil recirculating conduit 110 draws oil 104 via inlet 114, which is directly fluidly connected to an oil reservoir 112 and returns a “cleaned” oil (i.e., oil flow from which certain target contaminants are removed) via a return conduit 118 to the oil reservoir 112. Typically, a standard centrifugal, positive displacement, or other suitable pump 116 is employed to draw the oil 104 from the oil reservoir 112 and direct an oil flow 120, through one or more, or series of fluid flow cleaning devices, as shown in FIG. 1. In one embodiment, the oil flow 120 is preferably first directed through a barrier filter or equivalent mechanical filter 122, then through a water filter 124, and subsequently, through an electrostatic fluid cleaner 126. Preferably, the “cleaned” oil flow 128 is passed through a particle monitor 150 before returning to the oil reservoir 112.

In one aspect of the invention, the re-circulating conduit 110 is provided with a bypass conduit 130. The bypass conduit 130 is fluidly connected to the re-circulating conduit 110 at a tee or intersection intermediate the series of fluid flow cleaning devices 122, 124, 126 and the pump 116. Preferably, a pair of control valves 132, 134 are appropriately situated in the bypass conduit 130 and the re-circulating conduit 110, respectively, to direct the flow stream 120 in a predetermined manner. In further applications, a three-way valve may be employed in lieu of multiple valves. As will be further described below, in the normal operation, the oil flow 120 is directed through the open control valve 134 and through the fluid flow cleaning devices 122, 124, 126. In the normal operation, the control valve 132 upstream of the fluid flow cleaning devices 122, 124, 126 is set in the closed position.

In one aspect of the invention, one or more control mechanisms are provided on the re-circulating conduit 110 and in communication with the oil flow 120 discharged from the pump 116. For example, a temperature sensor 136 may be positioned between the reservoir 112 and the fluid flow cleaning devices 122, 124, 126 as shown in FIG. 1, thereby monitoring the temperature of the oil flow 120 discharged from the pump 116. The temperature sensor 136 may be set to send a signal or otherwise activate upon detection of a predetermined temperature (i.e., a high temperature) in the oil flow 120. The temperature sensor 136 is preferably operatively associated with the control valves 132, 134, and more particularly, actuators for the valves 132, 134, as generally known in the art. Thus, upon detection of the predetermined temperature of the oil flow 120, the temperature sensor 136 activates control valve 134 and valve 134 is moved to the closed position. Prior to this actuation or simultaneously therewith, the control valve 132 is actuated and moved to the open position. Accordingly, oil flow 120 is diverted into bypass conduit 130 and returned to the oil reservoir 112, without filtering.

In many applications, the temperature of the oil flow on the oil in the oil reservoir will gradually reduce and stabilize. For example, a temperature increase may have been caused by a spike or other irregularity in the relevant machinery or system (e.g., oil cooling system). In one embodiment, a preferred temperature sensor 136 is set at about 140° F. (60° C.). Such a setting is intended to protect elements of the electrostatic cleaner and the barrier and water filters from the effects of high temperature. Specifically, this temperature setting protects seals and other components found in the cleaning system. One suitable type of temperature is a thermocouple mounted on the oil flow conduit 110.

In another aspect of the invention, a water monitor or sensor 138 may be provided on the oil flow conduit 110 upstream of electrostatic fluid cleaner 126 and downstream of oil reservoir 112, and in fluid communication with the oil flow 120. Preferably, the water sensor 138 is provided at a location intermediate the pump 116 and the bypass conduit 130. The water sensor 138 may be set to sense or detect an aqueous content of the oil flow 120. Upon detection of this predetermined aqueous content, water sensor 138 actuates control valves 132, 134, in a manner similar to that described above in respect to temperature sensor 136. Specifically, control valve 134 is moved to the closed position while control valve 132 is moved into the open position. In this way, oil flow 120, which has been indicated to maintain an aqueous content above a predetermined level, is diverted into bypass conduit 130 and returned to oil reservoir 112.

Preferably, the barrier filter 122 is any one of various commercially available and suitable mechanical type filters. The barrier filter 122 includes a filter media selected to remove target contaminant particles in the oil flow and enhance the performance or longevity of the electrostatic fluid cleaner 126. Preferably, the filter media is selected to remove particulates as small as about 5 to 10 microns and, more preferably, as small as about 0.5 to 1.0 micron.

One suitable type of water filter is a water absorbent filter. When placed downstream of the barrier filter 122, as in the illustrated system, the filter rating of the water filter 124 can be higher (e.g., to reduce pressure drop in the system). In one embodiment, the water filter is configured to have the capacity to remove free and emulsified water to less than about 5 ppm. Such a water filter 124 may have a 3 to 5 micron rating for particle removal and a water holding capacity of 2 to 4 quarts.

As will become apparent to one skilled in the art, having the present disclosure, the water filter 124 becomes optional with inclusion of the bypass conduit 130 and water sensor 134. When employed in combination with the bypass conduit 130 and water sensor 134, the water filter 124 may function to remove aqueous content that is not quickly diverted from the electrostatic cleaner 126 by way of the bypass conduit 130. The water filter 124 may also function to filter intermittent aqueous content that may be below the limit set for the diversion of the oil flow via the bypass conduit 130 or that may pass by the water monitor 134 undetected, or pass during system irregularities. Inclusion of the water filter 124 does provide, however, additional protection and insurance that a high aqueous content oil flow does not reach the electrostatic cleaner 126. It should also be noted that the water filter 124 may be positioned intermediate the barrier filter 122 and electrostatic cleaner 126, as shown in FIG. 1, or elsewhere upstream of the electrostatic cleaner 126.

Referring to FIG. 1, the arrangement of fluid cleaning devices according to the invention effects a specific oil cleaning process utilizing the barrier filter 122 and the electrostatic fluid cleaner 126. The barrier filter 122 functions to remove larger sized particles which would otherwise shorten the useable life of the electrostatic cleaner 126. Preferably, the filter media of the barrier filter 122 is selected to have a pore size that will remove particles as small as 0.5 to 1.0 micron from the passing oil flow. Employment of an electrostatic cleaning process allows for the removal of contaminants of all or most sizes from the flow stream, including insoluble contaminants. In accordance with the present invention, the electrostatic cleaner is adapted to remove submicron contaminants, which are not removed by mechanical filtration.

Furthermore, the water filter 124 is advantageously positioned upstream of the electrostatic cleaner 126 so as to prevent the introduction of water into the electrostatic cleaner 126. The presence of water in the oil flow increases the conductivity of the oil. As the oil (which includes a high content of water) flows through the electrostatic cleaner, and more particularly, between the electrodes of the electrostatic cleaner, a higher current flow is established. The higher current flow presents a less than desirable situation, from a safety standpoint. Thus, the removal of aqueous content in accordance with the present invention is a preventative safety measure. Preferably, operation of the bypass conduit 130 will avoid such an introduction and reliance on the water filter 124 to fulfill this function. Moreover, the higher current flow would, otherwise, reduce the voltage in the electrostatic cleaner, thereby reducing the effectiveness of the electrostatic cleaner.

The present inventive system and method is particularly suited in applications wherein the industrial oil is used in conjunction with a plurality of servo valves and directional valves (e.g., hydraulic control systems). In these applications, degradation products in the submicron range (e.g., less than one micron) have the ability to escape the traditional or conventional filtering processes. These degradation products can collect on the surfaces of the servo valves and directional valves, thereby generating a tar or varnish on the surfaces. This varnish as well as additional particles that may stick to it is a primary cause for servo valves to malfunction or, more particularly, to “stick”. As a result, the hydraulic control system fails to operate in the expected or normal manner.

As a formulated oil (e.g., engine oils and most industrial oils) is used, it ages and oxidizes to form degradation products. Typically, the base oil is a mineral oil that is derived from refining of crude oil and generates oxidation products which are insoluble in the oil. The additives are also consumed and form their own degradation products. These oil degradation products are insoluble in the oil and contribute to the varnish and sludge that is generated by the aged oil. In one aspect of the present invention, the system and method are particularly suited for removing these oil degradation products from the oil. By employing the inventive method, the cleaned oil is free or is nearly free of oil degradation products. Accordingly, the potential for the generation of varnish and other material on the servo valves and directional valves of the hydraulic control system or other parts of the operating system is reduced, thereby enhancing the life and the performance of the system.

It should be noted that the above-described system and method is applicable to a number of industrial oil applications. In addition to turbine oil and hydraulic oil applications, the inventive system and method are applicable to use with compressor oils, gear oils, transformer oils and the like. Moreover, the system is not limited to implementation of a re-circulating conduit about a static reservoir. As will become apparent to one skilled in the art, having the present disclosure, the system may be modified for adaptation as an in-line system. Such in-line systems may be incorporated into portions of typical oil systems, i.e., systems which do not see regular flow from a main reservoir

FIG. 2 provides a simplified representation of the cleaning process according to the invention. This representation is provided for exemplary purposes and, therefore, should not be construed to limit the invention to the specific steps illustrated.

The inventive method provides an advantageous method of removing target contaminants from an oil flow. First, the oil flow is drawn (step 210) from an oil source such as an oil reservoir. In further applications, the oil source may be a main fluid system, as opposed to a static reservoir. In yet further applications, the oil cleaning system according to the invention may be incorporated “in-line” with the main fluid system. In this latter embodiment, the oil source is the main fluid system itself.

In the embodiment discussed previously and in respect to FIG. 1, the method employs a re-circulating conduit from and to the oil reservoir. In a subsequent step, the drawn oil is monitored for a predetermined aqueous content (step 214). This predetermined setting is an aqueous content in the oil flow that has been determined to lead to a significant reduction of the cleaning efficiency of the electrostatic oil cleaner or increase in the current flow in the electrostatic oil cleaner. The term aqueous content, as referred to herein, shall refer to both free aqueous content and water dissolved in oil. In one particular application, namely a hydraulic oil application, it is determined that a preferred aqueous setting is one below the saturation point (or 1.0 water activity level) of the oil. More preferably, the aqueous setting is about 0.75 water activity level or about 400 ppm, for hydraulic oil. In this and other applications, the aqueous setting is set at a level above which the voltage in the electrostatic oil cleaner will experience a significant drop (and decrease in cleaning efficiency). As discussed herein, such a voltage drop results from increased current flow in the passing oil, which is caused by the increase in the conductivity of the water-laden oil flow. Preferably, the predetermined setting is selected at a setting that is less than the saturation level in the oil (or 1.0 water activity level). If the aqueous content meets or exceeds the predetermined level, the oil flow is diverted (step 228) into a bypass conduit. Typically, the bypass conduit will discharge the diverted oil flow back to the oil reservoir. In this way, water contaminants are diverted away from the electrostatic cleaner.

If the aqueous content is below the predetermined level, the oil flow is passed through a barrier filter (step 218). The barrier filter removes certain particles from the oil flow (generally, the relatively larger particles which are larger than the submicron-sized particles). Preferably, the flow stream is maintained below between about 3.785 to 45.42 liters/min (1.0 to 12.0 gpm), and more preferably less than about 22.71 liters/min (6.0 gpm) (and more preferably, between about 5.68 to 20.82 liters/min (1.5 to 5.5 gpm)). At this relatively low rate and reduced fluid velocities, the potential for static electricity generation is minimized. Furthermore, the potential for a build-up of charge in the barrier filter is minimized. By specifying an appropriate flow rate(s) at which the oil flow may be pumped through the barrier filter, the inventive method provides one of the conditions for practical and effective use of the combination of barrier filter and electrostatic fluid filter.

Thereafter, the filtered oil flow exiting the barrier filter is passed through an electrostatic fluid cleaner. It is noted that the oil flow, at this point, is substantially free of larger contaminant particles. As a result, the cleaning process effected by the electrostatic cleaner is generally enhanced. More specifically, the electrostatic cleaner is more effective in removing insoluble, submicron material from the oil flow. The resultant cleaner oil flow may be passed through a particle monitor or equivalent, to check the effectiveness and efficiency of the cleaning process. After the filtered particle monitor, the oil flow, which is substantially free of insoluble submicron particles and water contaminants, is returned to the oil reservoir (step 226).

The many features and advantages of the present invention are apparent from the Detailed Description, and thus, it is intended by the appended claims to cover all such features and advantages of the invention which fall within the true spirit and scope of the invention. Further, since numerous modifications and variations will readily occur to those skilled in the relevant mechanical, chemical and other relevant art, it is not desired to limit the invention to the exact structures and operations illustrated and described herein. For example, various arrangements of the components of the oil filtering system described above, and/or the inclusion or absence of one or more of the described components may be employed and will readily be apparent to one skilled in the art (upon a reading and/or viewing of the present disclosure). Thus, the invention encompasses all different versions that fall literally or equivalently within the scope of the appended claims.

What is claimed is:

1. An oil cleaning system comprising:
an oil source;
an oil flow conduit in fluid communication with said oil source and operable to draw a flow stream therefrom;
a barrier filter positioned in said conduit to filter contaminants from said flow stream;
an electrostatic fluid cleaner positioned in said oil flow conduit downstream of said barrier filter to remove contaminants from oil flow exiting said barrier filter;
a selectively operable bypass conduit fluidly connected with said oil flow conduit upstream of said electrostatic fluid cleaner; and
a sensor operatively associated with said bypass conduit and positioned to detect a predetermined aqueous content in said flow stream upstream of said electrostatic fluid cleaner such that, upon detection of said predetermined aqueous content, said bypass conduit is activated to divert flow in said flow stream through said bypass conduit.

2. The system of claim 1, wherein said oil flow conduit is a re-circulating conduit having an inlet disposed in fluid communication with said oil source and a return conduit directed into said oil source.

3. The system of claim 2, wherein said bypass conduit is fluidly connected between said return conduit and a point in said oil flow conduit upstream of said electrostatic fluid cleaner.

4. The system of claim 1, further comprising a water filter positioned in said flow stream upstream of said electrostatic cleaner, said water filter being adapted to remove aqueous content from said oil flow.

5. The system of claim 4, wherein said water filter is positioned in said flow stream between said electrostatic fluid cleaner and said barrier filter.

6. The system of claim 1, wherein said sensor is a water monitor disposed on said oil flow conduit upstream of said electrostatic fluid cleaner.

7. The system of claim 6, further comprising at least one control valve positioned in said oil flow conduit and operatively associated with said water monitor such that said control valve is actuated to divert oil flow from said oil source into said bypass conduit upon detection of said predetermined aqueous content.

8. The system of claim 1, wherein said barrier filter includes a filter media having a pore size with a micron rating of at least 1 micron.

9. The system of claim 8, wherein said electrostatic fluid cleaner is configured to remove insoluble submicron particles from said flow stream.

10. The system of claim 1, further comprising a temperature sensor operatively associated with said bypass conduit and positioned to detect a predetermined oil flow temperature in said flow stream upstream of said electrostatic fluid cleaner and to divert flow in said flow stream through said bypass conduit.

11. The system of claim 1, wherein said oil source is an oil reservoir, said sensor being a water monitor adapted to detect the aqueous content in the flow stream of said oil and positioned in the oil flow conduit intermediate said electrostatic fluid filter and said oil source.

12. A method of removing contaminants from industrial oil, said method comprising the steps of:
drawing an oil flow stream from a source of industrial oil;
passing the flow stream through an oil flow conduit, including
passing the flow stream through a barrier filter to filter contaminants from the flow stream; and
passing the flow stream exiting the barrier filter through an electrostatic fluid cleaner to further remove contaminants from the flow stream; and
detecting an aqueous content in the flow stream upstream of the electrostatic fluid cleaner, including diverting the flow stream upstream of the electrostatic fluid cleaner through a bypass conduit upon detection of a predetermined aqueous content in the flow stream.

13. The method of claim 12, wherein said oil flow conduit is a re-circulating conduit fluidly connected with the oil source at an inlet and a return conduit.

14. The method of claim 13, further comprising the steps of:
positioning a water sensor in the oil flow conduit upstream of the electrostatic fluid cleaner, wherein the oil flow conduit further includes the bypass conduit for passing the diverted flow stream into the return conduit; and
wherein the oil flow conduit includes a plurality of valves operatively associated with the water sensor, said detecting step including operating the water sensor to actuate the plurality of control valves in the oil flow conduit upon detection of the predetermined aqueous content, thereby diverting the flow stream into the bypass conduit.

15. The method of claim 12, further comprising the steps of:
positioning a temperature sensor in the oil flow conduit upstream of the electrostatic fluid cleaner, wherein the temperature sensor is configured to detect a predetermined temperature in the flow stream; and
upon detection of the predetermined temperature in the flow stream, operating the sensor to divert the flow stream upstream of the electrostatic cleaner into a bypass conduit.

16. The method of claim 12, further comprising the steps of:
providing a barrier filter having a filter media rated at least about 1 micron, said step of passing the flow stream through the barrier filter including filtering particles 1 micron or larger from the flow stream; and
wherein said step of passing the flow stream through an electrostatic fluid cleaner, includes removing insoluble, submicron particles from the flow stream.

17. The method of claim 16, wherein the oil flow stream includes insoluble contaminants including oil degradation products, said step of passing the flow stream through the barrier filter including passing a flow stream having oil degradation products therein to the electrostatic fluid cleaner; and
wherein said step of passing the flow stream through an electrostatic fluid cleaner, includes removing insoluble submicron particles including oil degradation products from the flow stream.

18. The method of claim 16, wherein said drawing and passing steps include passing the flow stream at a flow rate between about 1.89 liters/min to about 22.71 liters/min.

19. The method of claim 16, further comprising the steps of:
positioning a water filter upstream of said electrostatic fluid cleaner; and
before said step of passing the flow stream through said electrostatic fluid cleaner, passing the flow stream through the water filter.

20. The method of claim 16, wherein said detecting step includes detecting a predetermined aqueous content of about 500 ppm.

21. A method of removing contaminants, including insoluble, submicron particles of oil degradation products, from industrial oil, said method comprising the steps of:
drawing an oil flow stream containing submicron particles including oil oxidation products, from a source of industrial oil;
passing the oil flow stream through an oil flow conduit, including passing the flow stream through a barrier filter to filter particles larger than about 0.5 micron from the flow stream;
passing the flow stream exiting the barrier filter through an electrostatic fluid cleaner to remove insoluble, submicron particles from the flow stream, including oil degradation products; and
detecting an aqueous content of the flow stream upstream of the electrostatic fluid cleaner, including diverting the flow stream upstream of the electrostatic fluid cleaner into a bypass conduit upon detection of a predetermined aqueous content in the flow stream.

22. The method of claim 21, wherein the oil flow conduit is a re-circulating conduit fluidly connected with the oil source at an inlet and at a return conduit, said method further comprising the step of returning clean oil flow exiting the electrostatic fluid cleaner to the oil reservoir.

23. The method of claim 22, wherein the oil flow conduit further includes a bypass conduit for passing the diverted flow stream into the return conduit, and a plurality of valves movable to divert flow into the bypass conduit, said method further comprising the steps of:
positioning a water sensor in the oil flow conduit upstream of the electrostatic fluid cleaner; and
said detecting step including operating the water sensor to actuate the valves in the oil flow conduit upon detection of the predetermined aqueous content, thereby diverting the flow stream into the bypass conduit.

24. The method of claim 23, further comprising the step of setting the predetermined aqueous content at a value of between about 400 ppm to about 500 ppm.

25. The method of claim 21, further comprising the steps of:
positioning a temperature sensor in the oil flow conduit upstream of the electrostatic cleaner, the temperature sensor being configured to detect a predetermined temperature in the flow stream; and
upon detection of the predetermined temperature in the flow stream, operating the sensor to divert the flow stream upstream of the electrostatic fluid cleaner into the bypass conduit.
